(19) United States
(12) Patent Application Publication
(10) Pub. No.: US 2003/0097284 A1
(43) Pub. Date: May 22, 2003

(54) Online-reservation system and method with automatic canceling function

(76) Inventor: Noboru Shinozaki, Tokyo-to (JP)

Correspondence Address: NIXON & VANDERHYE P.C., 8th Floor, 1100 North Glebe Road, Arlington, VA, 22201-4714, US

(21) Appl. No.: 10/288,299

(22) Filed: Nov. 6, 2002

(30) Foreign Application Priority Data
Nov. 20, 2001 (JP) P2001-354072

(51) Int. Cl. G06F 17/60

(52) U.S. Cl. 705/5

(57) ABSTRACT

An online-reservation system is provided for managing an online-reservation offered from a terminal communicably connected through a commination network. In the system, information about a reservation for an event taken place in a facility is received from the terminal via the communication network. The reservation is made by a user. Also positional information comes from the terminal via the communication network so as to manage a current position of a user who made the reservation. Both the received reservation information and the received current position the user are managed. In cases where the user moves out of a predetermined area enclosing the facility, the reservation is automatically cancelled.

### BACKGROUND OF THE INVENTION

The present invention relates to an online-reservation system, and in particular, to the system and method that enables on-line reservations of users and additionally has the capability of automatically canceling reservations under particular conditions.

In recent years, online data processing carried out via a network such as Internet has been widely used, in which a plurality of users can share the same data vie the network.

In addition, as one type of the online information processing, there has already been provided an online reservation service system that permits a user to use a potable communication terminal in order to reserve a variety of events, such as an attraction or concert. In this system, a user first makes only an online reservation, goes to a facility, such as a theater, that performs an event, and buys a ticket for the event.

However, the foregoing online reservation service system has faced the problem that some persons who have online-reserved, for example, seats at a theater in advance (but tickets has yet to be bought), but they will not come to the theater. It is very difficult for the theater to determine in advance if the persons who made online-reservations have really come to the theater or not. If some persons would not come to the theater even if they made online-reservations, the theater is forced to perform an event with vacant seats left.

This causes the theater to be obliged to handle customers in a poor manner. Even if there are some customers who would like to offer tickets if seats would be available, the theater could not respond to their offers timely before the event or performance begins. In addition, carrying out an event or performance with vacant seats left leads to a decrease in business performance.

### SUMMARY OF THE INVENTION

The present invention has been made in view of the above circumstances, and an object of the present invention is, therefore, to provide an online-reservation system and method that enables facilities such as a theater to cope with persons who made a reservations, but does not come to the facilities to buy tickets when an event or performance is carried out.

In order to achieve the above object, there are provided a facility-reserving management server, a method of managing an online-reservation for a facility, and a program installed in a computer system for an online-reservation. An online-reservation is offered from a terminal communicably connected through a commination network is managed. Information about a reservation for an event taken place in a facility is received from the terminal via the communication network. The reservation is made by a user. Also positional information comes from the terminal via the communication network so as to manage a current position of a user who made the reservation. Both the received reservation information and the received current position the user are managed. In cases where the user moves out of a predetermined area enclosing the facility, the reservation is automatically cancelled.

Accordingly, if a user who made a reservation for a ticket at an event in a facility goes out of the predetermined area enclosing the facility, such as an amusement park, the reservation will be cancelled automatically. Hence, it is possible to avoid a situation in which a user who made a reservation, but returns without actually attending a reserved event taken place in the facility. The number of actual attendants at the event can therefore be grasped more accurately before performing the event, thereby being able to handle the attendants in a good manner. A business performance for performing the events at the facility is also improved.

Preferably, only the reservation offered from the terminal that is present within the predetermined area is accepted. Still preferably, it is to notify the terminal of canceling the reservation by an electronic mail.

It is also preferred that the reservation is kept even when the user goes out of the area, in cases where a notification that the user temporarily goes out of the area is issued from the terminal before a start of the event.

Still it is preferred that the user is allowed to make the reservation from outside the area, in cases where the user has a membership authorized by an operator of a system adopting the method.

### BRIEF DESCRIPTION OF THE DRAWINGS

Other objects and aspects of the present invention will become apparent from the following description and embodiments with reference to the accompanying drawings in which:

FIG. 1 is a block diagram showing an outlined configuration of a facility online-reservation system according to one embodiment of the present invention;

FIG. 2 is a block diagram outlining the configuration of a terminal incorporated in the facility online-reservation system;

FIG. 3 shows an outlined block diagram of a management server incorporated in the facility online-reservation system;

FIG. 4 explains the sequences of processing carried out in a mutually communicated manner by both the management server and the terminal;

FIG. 5 exemplifies a reservation-entry picture (screen) displayed by the terminal, the reservation-entry picture being used by users to input data for a reservation;

FIG. 6 exemplifies a reservation-accepted picture (screen) displayed by the terminal;

FIG. 7 is a flowchart showing the processing of whether or not a reservation is approved or not, which is carried out by the management server; and

FIG. 8 is a flowchart showing the processing to cancel a reservation, which is carried out by the management server.

### DETAILED DESCRIPTION OF THE PREFERRED EMBODIMENT

The present invention will now be described with reference to preferred embodiment.

In the following embodiment, the online-reservation system in accordance with the present invention is practiced into a facility online-reservation system, in which a server is connected to terminals through a communication network such as Internet. The terminal, which is a mobile phone MP, mobile information terminal such as a personal digital assistance (PDA) unit, or personal computer PC, is communicable to the server. In the present embodiment, the server is in charge of receiving reservations of attractions performed at an amusement park (i.e., facility).

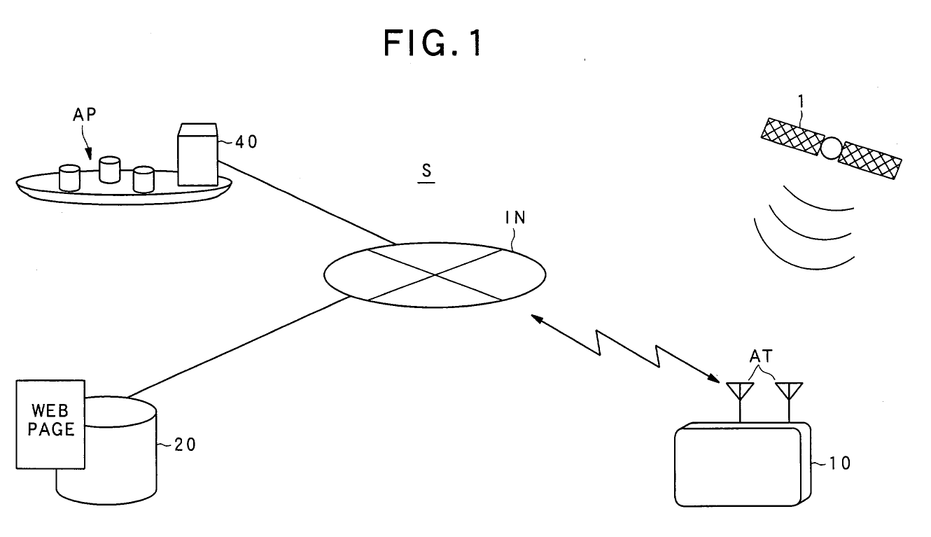

FIG. 1 outlines a facility online-reservation system S according to the present embodiment. The facility online-reservation system S is provided with a plurality of terminals 10 (in FIG. 1, only one terminal is illustrated) which are used to reserve events taken place at facilities, a management server 20 serving as a facially-reserving management server of the present invention, an attraction manager 40, and the Internet IN communicably linking the terminals 10, management server 20, and attraction manager 40 one from another.

Of these, the management server 20, attraction manager 40, and Internet IN are formed into the online-reservation system according to the present embodiment.

In the facility online-reservation system S shown in FIG. 1, each terminal 10, which is formed as a mobile communication terminal, receives GPS (Global Positioning System) data from GPS satellites 1 to acquire current positional information about the terminal 1.

The management server 20 is responsible for the reception and management of information indicative of reservations for an attraction offered from users via the Internet IN, the reception and management of data indicative of the current position of the terminal 10 (i.e., a user who made a reservation), and management for reserving attractions at the amusement park AP. The management for reserving attractions performed by the management server 20 includes cancellations of reservations. That is, when a user who reserved seats at an attraction has been moved outside a predetermined area containing the amusement park AP, the management server 20 detects such a user's movement and cancel the reservation.

The attraction manager 40, which is disposed at the amusement park AP, acquires information about reservations and others from the management server 20 via the Internet 20 in order to manage reservations for attractions.

The terminal 10 is carried by a user, who can use the terminal 1 to make a reservation for seats at an attraction carried out in the amusement park AP. Hence the terminal 10 is able to permit the user to input data necessary for making a reservation for seats at any attraction and to receive, from the management server 20 via the Internet IN, an electronic mail notifying that the reservation has been canceled under particular conditions.

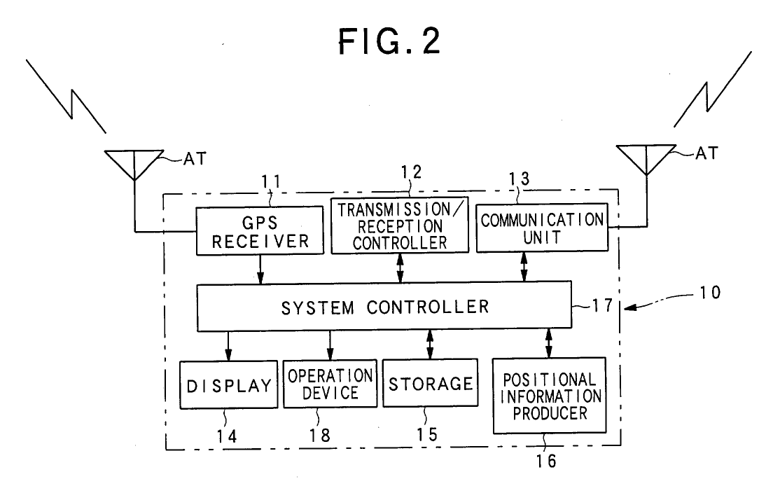

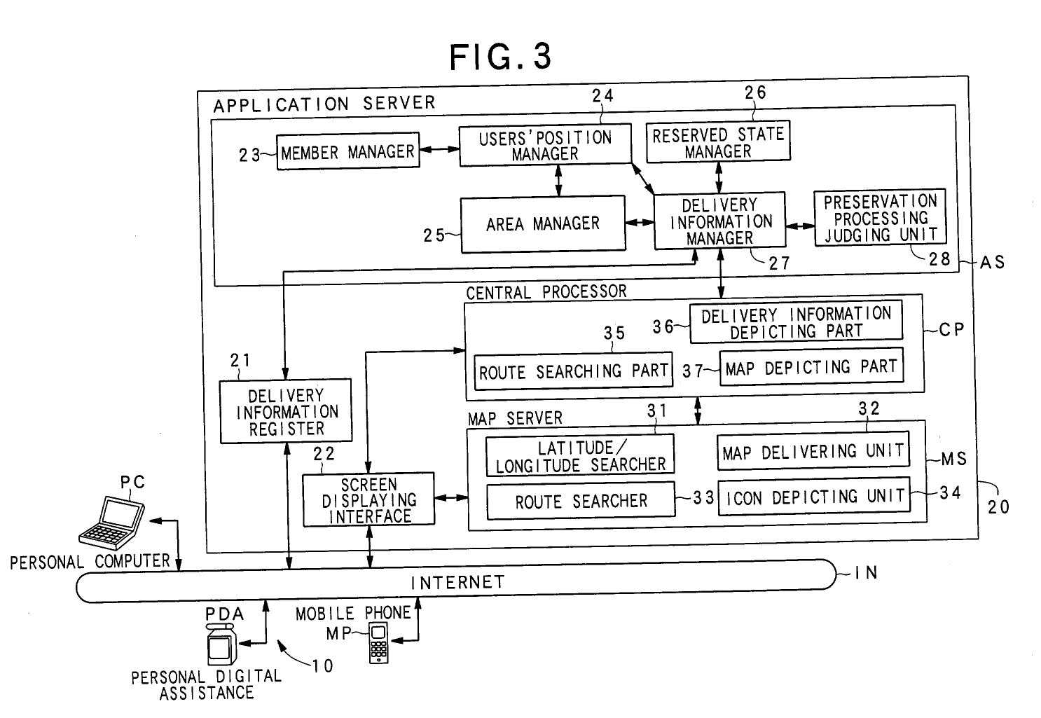

Referring to FIGS. 2 and 3, the terminal 10 and management server 20 will now be described in detail, respectively. FIGS. 2 and 3 show the functional block diagrams of the terminal 10 and the management server 20, respectively.

As shown in FIG. 2, the terminal 1, which is coupled with two antennas AT, is equipped with various components. The components include a GPS receiver 11, transmission/reception controller 12, communication unit 13, display 14, storage 15, positional information producer 16, system controller 17, and operation device 18.

Of these, the GPS receiver 11 receives GPS the data via one antenna and the transmission/reception controller 12 manages regularly transmitted conditions of the current position of a user who made a reservation for seats at an attraction. The communication unit 13 is also coupled with the other antenna AT and in charge of transmitting necessary data to the management server 20 or attraction manager 40 via the antenna AT. The display 14 is responsible for displaying information indicating reservations for attractions, a reservation-accepted picture (screen; serving as a ticket picture displayed when a reservation is accepted), and information acquired from the management server 20 with the aid of electronic malls.

Further, the storage 15 is placed to store various kinds of data including that of a reservation-accepted picture. The positional information producer 16 will produce data indicating the current position of each terminal 1 with the aid of GPS data received via the GPS receiver 11. The system controller 17 uses both of received data and stored data in the storage 15 so that it controls not only the operation of each component in the terminal 10 but also an reservation offer to the management server 20. The operation device 18 is placed to allow a user to give pieces of necessary information to the terminal 10.

The GPS receiver 11 is configured to receive navigation radio waves coming from the GPS satellites through the antenna AT, and computes pseudo-coordinates corresponding to the current position of each user (i.e., the terminal 1) so as to provide the pseudo-coordinates (i.e., GPS data) to the system controller 17.

Referring to FIG. 3, the management server 20 will now be explained.

In the present embodiment, the personal computer PC, mobile personal digital assistance PDA units, and mobile phone MP have the same function in terms of their information providing functions. Those units are therefore noted as a terminal 10 serving as a communication terminal.

As shown in FIG. 3, in general, the management server 20 is provided with an application server AS, central processor CP, map server 21, delivery information register 21, and screen displaying interface 22.

The delivery information register 21 intervenes between the Internet IN and the application server AS so that it relays information therebetween. Also the screen displaying interface 22 is placed to relay information between the Internet IN and the central processor CP and map server MS, so that the controller 22 is able to control the display on the terminal 10.

The application server AS includes a member manager 23, users' position manager 24 serving as position managing means, area manager 25 serving as area managing means, reserved state manager 26 serving as reserved information managing means, delivery information manage 27 serving as reservation receiving means, and reservation processing judging unit 28 serving as reservation canceling means.

The member manager 23 is configured to relay necessary pieces of information to and from the users' position manager 24. The users' position manager 24 is able to send and receive pieces of information to and form both of the area manager 25 and delivery information manager 27. The area manager 25 is placed to send and receive pieces of information to and from both the users' position manager 24 and the delivery information manager 27. The reserved state manager 26 is placed to communicate with the delivery information manager 27. Further, the delivery information manage 27 is arranged to communicate with the area manager 25, users' position manager 24, reserved state manager 26, reservation processing judging unit 28, delivery information register 21, and the central processor CP.

The map server MS, which is able to communicate with both of the central processor CP and the screen displaying interface 22, includes a latitude/longitude searcher 31, map delivering unit 32, route searcher 33, and icon depicting unit 34.

Moreover, the central processor CP is configured so that it is in charge of data communication to and from the screen displaying interface 22, deliver information manager 27, and map server MS. More practically, the central processor CP functionally includes a route searching part 35, delivery information depicting part 36, and map depicting part 37.

Each of the foregoing components will now be detailed.

The delivery information register 21 serves as a communication interface between the delivery information manager 27 and the terminal 10 (such as the personal computer PC, mobile information digital assistance PAD, or mobile phone MP) and is communicable with the terminal 10 via the Internet IN.

The screen displaying interface 22 has the ability of displaying various kinds of information, such as information to be reserved coming from the terminal 10 by way of the Internet IN, the map of a predetermined area for cancellation processing for reservations. This unit is also able to display the area containing the amusement park area, the locations of attractions, and the current position of a user who made a reservation for seats at an attraction.

The components in the application server AS will now be described. The member manager 23 engages in management processing for previously registered members' IDs (identifications), logs for user on a reservation basis of the users who made reservations, and others. The users' position manager 24 is configured to manage information showing the current positions of all the users who made reservations. Only qualified members who have been registered in the management server 20 are allowed to make a reservation in this amusement park AP. The area manager 25 is configured to manage different areas for cancellation processing. The areas are previously decided attraction by attraction. The reserved state manager 26 is responsible for management of reserved states for every attraction. Further, the delivery information manager 27 is assigned to management of information about reservations delivered from and to users who made a reservation. Still further, the reservation processing judging unit 28 is formed to judge whether a reservation for an attraction is to be permitted or not and whether a reservation that has been once made should be cancelled or not.

Further, in the map server MS, the latitude/longitude searcher 31 searches data indicating the current positions of users who made reservations for attractions, that is, information about both latitude and longitude of each user. Only the members who are registered previously in the management server 20 are allowed to make such reservations. The map delivering unit 32 delivers to the central processor CP information such as map data necessary for displaying a map desired by a user, so that the map data and other necessary information are sent to the terminal 10 through the Internet IN. The route searcher 13 responds to a route request from each user who made a reservation for a desired attraction so that it searches a route connecting the current position of the user to a spot at which the desired attraction will be taken place. Further, the icon depicting unit 34 operates so as to depict an icon on a picture to be displayed on the terminal 10 under the control of the screen displaying interface 22.

The central processor CP will now be explained with its functional blocks. The route searching part 35 operates in response to a request from each user who made a reservation for a desired attraction, so that it produces data of a route display picture showing a route from the current position of the user to a spot where the attraction will be performed. The delivery information depicting part 36 has the capacity of producing various types of pictures including a reservation-accepted picture (serving as a reservation ticket), a picture displaying a crowded state at the attraction, and a picture displaying a predetermined area in which the user should remain. In the present embodiment, if the user goes out of the predetermined area, the reservation will be canceled. Therefore, the predetermined area is called a “canceling area” to mean an area to cancel reservations, provided that such a particular condition is established. The map depicting part 37 is able to receive map data outputted from the foregoing map delivering unit 32 and makes the terminal 10 to display thereon a map based on the map data under the control of the screen displaying interface 22. The map thus depicted includes a spot where an offered attraction will be taken place, the above-explained predetermined canceling area, and the current self-position of a user.

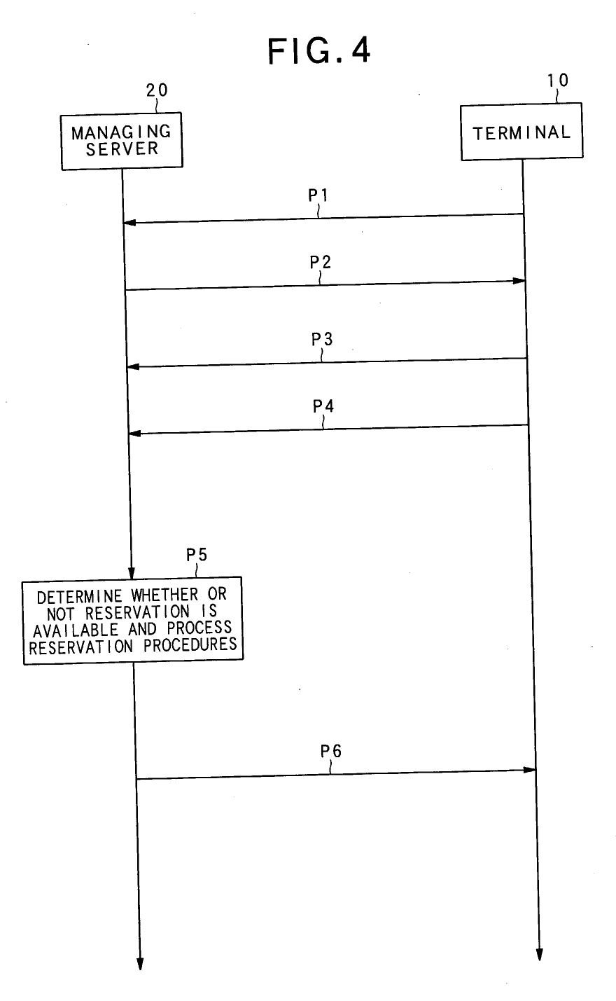

Referring to FIGS. 4 to 8, the processing for reserving events taken place in the amusement park AP will now be explained. The management server 20, in which its various kinds of functions described above work in a mutually cooperative manner, carries out the processing for reservations.

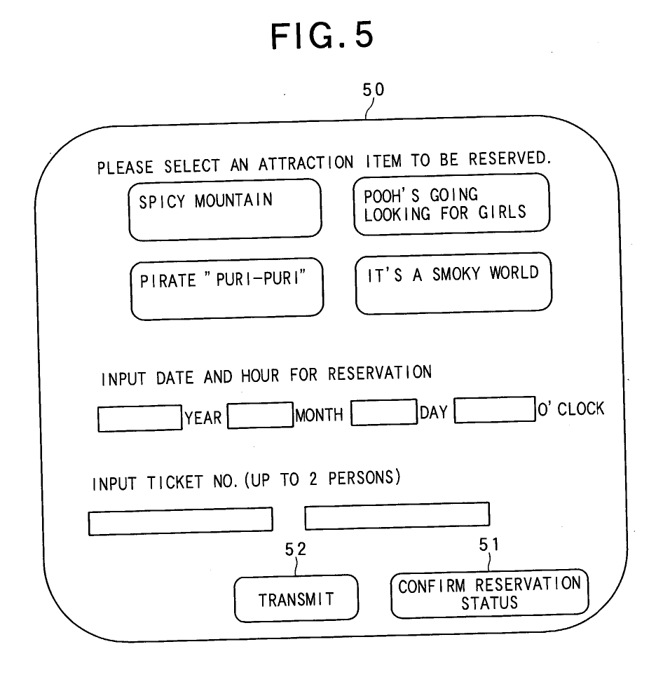

As shown in FIG. 4, a user (a member of the amusement park AP) first operates a user's terminal 10 (such as a mobile phone MP) so access to a member-only reservation page established as a homepage by the management server 20 through the Internet IN (step P1). In operating the terminal 10, it is requested that the user input a user's ID number. Responsibly to this access, the management server 20 performs individual authentication on the received ID number. After the authentication results in approval of the ID number, the managing server 20 sends, to the terminal 10 via the Internet IN, data indicative of a reservation-entry picture 50, as shown in FIG. 5, to be displayed on the screen of the terminal 10 (step P2).

Then, the user views the reservation-entry picture 50 that has been displayed on the terminal 10 and select a desired item (attraction) from one or more items (attractions) listed in the picture 50. For example, the user selects the attraction of “spicy mountain” as a desired attraction among the listed various attractions. After this selection, the user is requested to input the reservation date and time such as “15:15 on Mar. 10, 2002.” While the selection is performed, the user can press a reserved state confirmation button 51. Responsively to this pressing operation, the current picture is transferred to a new picture operation to confirm the currently reserved states of the attractions. After reviewing this conformation picture, the user is able to input the number(s) of the ticket(s) for a desired user number, for example, for two persons, and then press a transmission button 52. Hence from the terminal 10 to the management server 20 via the Internet IN, information indicating a desired attraction to be reserved, a date and time to be reserved, and the ticket numbers are sent (step P3).

The user also handles the terminal 10 to make it to transmit information showing its current position to the management server 20 (step P4).

On the other hand, the management server 20 performs processing that determines whether or not the reservation is acceptable or not, based on the information about the desired attraction to be reserved, the date and time to be reserved, the ticket numbers, and the current position of the user (i.e., the terminal 10) who is under operations. In addition to this determination, the server 20 performs processing to register reservation, only if the reservation that has been offered is acceptable (step P5).

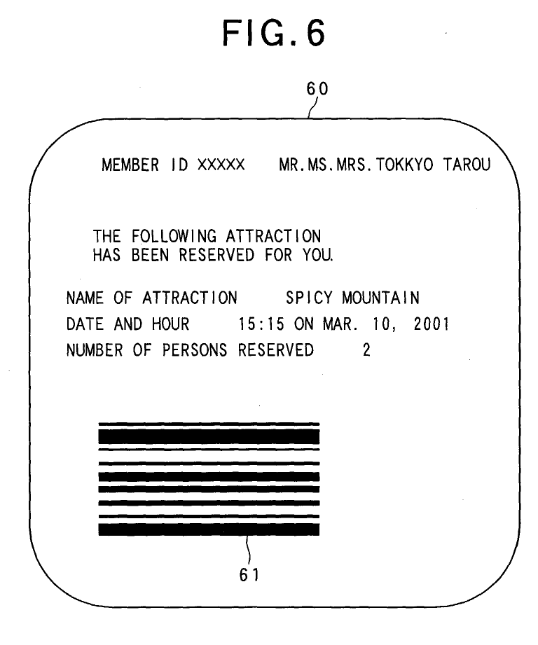

The management server 20 operates so as to transmit a notification that the offered reservation has been accepted and completed (step P6). The notification also functions as a ticket to show that the reservation has made (i.e., reservation ticket). This nonfiction is displayed on the display 14 of the terminal 10 in the form of a reservation-accepted picture 60 shown in FIG. 6.

Practically, the reservation-accepted picture 60 includes, as shown in FIG. 6, the member's ID number, the name of a person who made a reservation, the name of a reserved attraction, the date and time, the number of persons, a barcode 61 showing the above various kinds of information in relation to this reservation. The displayed information as the reservation-accepted picture 60 is effective as a ticket that entitles the user(s) to participate in the attraction actually performed. The reservation-accepted picture 60 can be used as the above actual ticket just as it is, or can be printed for a printed ticket.

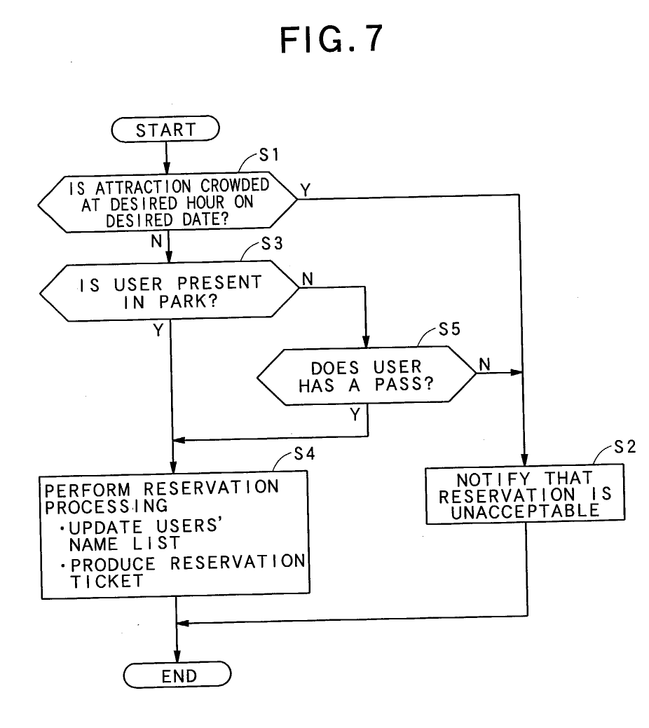

In the present embodiment, the processing for determining if the reservation can be accepted or not is carried out the management server 20 on the basis of the procedures shown in FIG. 7.

As shown in FIG. 7, first of all, the management server 20 determines whether or not the offered attraction on the offered date an time is already crowed with (full of) other reserved persons (step S1). If the attraction is already crowded on the offered date and time (YES at step S1), by sending an electronic mail, the management server 20 notifies the terminal 10 carried by the user of the fact that the offered reservation cannot be accepted (step S2).

On the other hand, when the attraction is not crowded on the offered date and time, that is, there are empty seats in the offered attraction to be carried out on that offered date and time (YES at step S1), the processing is made to proceed to step S3.

At this step S3, the management server 20 further determines if or not the user who made a reservation is within the amusement park AP containing the area where the offered attraction is take place. If the user is within the park AP (YES at step S3), the management server 20 proceeds to the performance of various kinds of processing for accepting the reservation (step S4). This processing includes the update of a name list of the users who have made reservations so far and the production of data for representing a reservation ticket.

On the other hand, in cases where the user engaged in the reservation is not within the park AP at present (i.e., the user went outside the park AP before making a reservation or the user has been outside the park AP) (NO at step S3), the processing is handed to step S5. In this case, the management sever 20 further performs a determination whether or not the user has a pass such as an year-round pass (step S5). If the user has such a pass (YES at step SS), the processing is made to go to step S4 described above, where the same processing (the processing for accepting the reservation) is carried out. By contrast, when the user has not any pass (NO at step S5), the processing is handed to step S2 described before, at which an electronic mail notifying the user of the fact that the reservation has been unaccepted is sent out to the terminal 10.

In the present embodiment, reservations offered by the members who have passes are accepted, even when such users are still outside the park AP, because they have already paid visitor fee for the park AP. As understood from the processing shown in FIG. 7, ordinary visitors other than such members having passes are entitled to make a reservation after entering the amusement park AP (that is, after paying the park for admission. As a result, through the processing described above, it is determined about whether each offer of a reservation is acceptable or not.

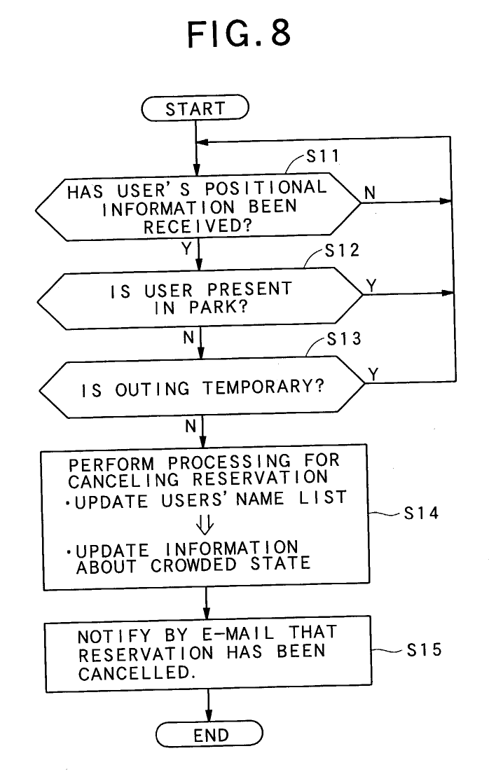

Next, the processing shown in FIG. 8 will now be described.

As shown in FIG. 8, the management server 20 determines whether or not the positional information about the user who made a reservation has bee received (step S11). The management server 20 waits for until the positional information is received, with the determination at step S11 repeated regularly. If the determination is YES at step S11 (that is, the positional information has been received), the processing is made to go to step S12, where the management server 20 (i.e., the user's position manager 24) determines if the user who offered a reservation is present within the amusement park AP.

If the user is present within the park AP, the management server 20 waits for until the determination at step S12 becomes negative. That is, until the user goes out of the park AP, the processing shown in FIG. 8 is stopped to go to further steps. In cases where the user goes out of the park AP (NO at step S12), it is immediately determined whether or not the outing from the park AP is temporary (step S13).

When the user who made a reservation desired to go out of the park AP temporarily before the reserved attraction starts, the user can use the terminal 10 to notifies the management server 20 of his or her temporary outing. In such a case, the management server 20 detects that the outing is temporary (YES at step S13), thus the processing entering into its waiting state, with repeating steps S11 to S13.

By contrast, when the management server 20 detects that the outing is not temporary (NO at step S13), the processing is made to advance to step S14, where the reservation once accepted is cancelled. In other words, the reserved users' list is updated and the information about the crowdedness in the park AP is also updated.

The management server 20 then performs its processing at step S15, where the server 20 sends to the terminal 10 (that is, the user who made a reservation) an electronic mail notifying that the reservation is automatically cancelled under the predetermined regulations at steps S12 and S13.

Alternatively, the canceling processing can be modified as follows. Practically, the processing at step S15 can be altered as follows. When the management server 20 receives, from the user who received the canceling notification, a reply that the reservation should be revived, and detects that the user returns to the park AP, within a period of predetermined time after the cancellation, the server 20 deletes the cancellation. In such a case, the reservation once cancelled will be revived.

Accordingly, the processing for canceling the reservation under particular conditions can be done as above by the management server 20.

As described above, the facility online-reservation system S is able to provide various advantages as follows. Practically, if a user who made a reservation goes out of the park AP serving as a predetermined area, the reservation will be cancelled automatically. Hence, it is possible to avoid a situation in which a user who made a reservation, but returns without actually attending a reserved attraction in the park AP. The number of actual attendants at an attraction can therefore be grasped more accurately before performing the attraction, thereby being able to handle the attendants in a good manner.

Moreover, in the present embodiment, the reservation is acceptable, provided that users are present in the amusement park AP that is a predetermined area. Hence only the persons who are within the park AP, thus having a higher possibility that makes use of the facility, is entitled to offer reservations.

When the reservation once accepted is canceled, the fact that the cancellation has been made is notified of the user by an electronic mail. Accordingly, the user can find it in a steady manner that notification of a cancellation was issued.

Further, in cases where a user notifies the management server 20 of a temporary outing from the amusement park AP before starting an attraction, the reservation once accepted is kept. This way of keeping the reservation avoids user's re-reserving operations, thereby increasing operational efficiency.

In the present embodiment, as long as a user offered a reservation is a registered member, the user can make a reservation from outside the amusement park AP. Thus, a privilege can be granted to the members.

In the present embodiment, the programs in which the procedures shown in FIGS. 4, 7 and 8 are written are stored in information recording mediums such as flexible disk or hard disks. The programs are read out by CPUs (computers) incorporated in the server W in order to realize the predetermined functions of the application serer AS, central processor CP, and map server MS.

The present invention may be embodied in other specific forms without departing from the spirit or essential characteristics thereof. The above embodiments and modifications are therefore to be considered in all respects as illustrative and not restrictive, the scope of the present invention being indicated by the appended claims rather than by the foregoing description and all changes which come within the meaning and range of equivalency of the claims are therefore intended to be embraced therein.

For instance, the above embodiment has been described about reservations for seats at the attractions taken place in the amusement park AP, but the present embodiment will not be limited to such a facility. For example, the facilities to which the present invention can be applied range over a variety of other performances or events, such as a concert, sports, and movies, which are taken place within a predetermined limited area.

Further, both of the management server 20 and the attraction manager can be combined into one server that performs the foregoing various operations.

The entire disclosure of Japanese Patent Application No. 2001-354072 filed on Nov. 20, 2001 including the specification, claims, drawings and summary is incorporated herein by reference in its entirety.

What is claimed is:

1. A facially-reserving management server to which a terminal is communicably connected through a commination network, comprising:
a reservation receiving unit configured to receive information about a reservation for an event taken place in a facility from the terminal via the communication network, the reservation being made by a user;
a reservation managing unit configured to manage the received reservation information;
a position managing unit configured to receive positional information coming from the terminal via the communication network and to manage a current position of a user who made the reservation; and
a reservation canceling unit configured to cancel the reservation in cases where the user moves out of a predetermined area enclosing the facility.

2. The facially-reserving management server of claim 1, wherein the reservation receiving unit includes a unit configured to accept only the reservation offered from the terminal that is present within the predetermined area.

3. The facially-reserving management server of claim 1, further comprising a notification unit configured to notify the terminal of the cancellation of the reservation by an electronic mail.

4. The facially-reserving management server of claim 1, further comprising a reservation keeping unit configured to keep the reservation even when the user goes out of the area, in cases where a notification that the user temporarily goes out of the predetermined area is issued from the terminal before a start of the event.

5. The facially-reserving management server of claim 1, wherein the reservation receiving unit includes a unit configured to allow the user to make the reservation from outside the area, in cases where the user has a membership authorized by an operator of the facially-reserving management server.

6. A method of managing an online-reservation, which is carried out by a facility-reserving management server connected to a communicable terminal through a communication network, the online-reservation being issued from the terminal, the method comprising the steps of:
receiving information about a reservation for an event taken place in a facility from the terminal via the communication network, the reservation being made by a user, and positional information coming from the terminal via the communication network so as to manage a current position of a user who made the reservation;
managing both the received reservation information and the received current position the user; and
canceling the reservation in cases where the user moves out of a predetermined area enclosing the facility.

7. The method of claim 6, wherein the receiving step includes a step of accepting only the reservation offered from the terminal that is present within the predetermined area.

8. The method of claim 6, further comprising the step of notifying the terminal of the cancellation of the reservation by an electronic mail.

9. The method of claim 6, further comprising the step of keeping the reservation even when the user goes out of the area, in cases where a notification that the user temporarily goes out of the area is issued from the terminal before a start of the event.

10. The method of claim 6, wherein the receiving step includes a step of allowing the user to make the reservation from outside the area, in cases where the user has a membership authorized by an operator of a system adopting the method.

11. The method of claim 6, further comprising the step of acquiring the information about the reservation from the facility-reserving management server to manage the reservation for the facility.

12. A program installed in a computer system for managing an online-reservation offered from a terminal communicably connected through a commination network, the program enabling the computer system to functionally perform the steps of:
receiving information about a reservation for an event taken place in a facility from the terminal via the communication network, the reservation being made by a user, and positional information coming from the terminal via the communication network so as to manage a current position of a user who made the reservation;
managing both the received reservation information and the received current position the user; and
canceling the reservation in cases where the user moves out of a predetermined area enclosing the facility.

13. The program of claim 12, wherein the receiving step includes a step of accepting only the reservation offered from the terminal that is present within the predetermined area.

14. The program of claim 12, further comprising the step of notifying the terminal of the cancellation of the reservation by an electronic mail.

15. The program of claim 12, further comprising the step of keeping the reservation even when the user goes out of the area, in cases where a notification that the user temporarily goes out of the area is issued from the terminal before a start of the event.

16. The program of claim 12, wherein the receiving step includes a step of allowing the user to make the reservation from outside the area, in cases where the user has a membership authorized by an operator of the computer system.
